(19) United States
(12) Patent Application Publication
(10) Pub. No.: US 2014/0100111 A1
(43) Pub. Date: Apr. 10, 2014

(54) Seed Coating Hydrogels

(71) Applicants: Thomas M. Schultz, SR., Millsboro, DE (US); Arthur H. Finnel, Moorestown, NJ (US); George L. Collins, Maplewood, NJ (US)

(72) Inventors: Thomas M. Schultz, SR., Millsboro, DE (US); Arthur H. Finnel, Moorestown, NJ (US); George L. Collins, Maplewood, NJ (US)

(21) Appl. No.: 13/772,608

(22) Filed: Feb. 21, 2013

Related U.S. Application Data
(60) Provisional application No. 61/709,956, filed on Oct. 4, 2012.

(51) Int. Cl. C09D 189/00

(52) U.S. Cl. CPC C09D 189/00
USPC 504/140; 427/372.2

(57) ABSTRACT

A bio-degradeable seed coating composition for enhanced seed protection and propagation comprises a gelatin-based hydrogel formulation consisting of a naturally derived, hydrophilic protein in combination with a sulfated or non-sulfated polysaccharide. The protein is animal porcine or bovine derived while the polysaccharide is preferably a cellulose derivative such as sodium cellulose sulfate, dextran sulfate, sulfated chitosan, sulfated starch and mixtures thereof. The seed coating composition may also comprise a rheology modifier comprising a clay, a dessicant or silica gel.

### CROSS-REFERENCE TO RELATED APPLICATIONS

This application claims the benefit of priority of U.S. Provisional Appln. No. 61/709,956 filed on Oct. 4, 2012.

### FIELD OF THE INVENTION

The present invention relates generally to agricultural and horticultural applications and improved methods for enhanced seed protection and propagation. More specifically, the present invention is focused on hydrogel compositions and methods for their use in improved seed germination, propagation, and plant growth for increased crop production and yields.

### BACKGROUND OF THE INVENTION

There have been numerous biotechnological and agricultural advances over the years utilizing seed and plant hybridization techniques yielding new species and greater crop yields. Methods for enhanced seed germination and embryonic plant development have also been explored but there is still much in the area for improvement. Vegetation has been utilized to provide aesthetic value and soil stabilization for many years. One particular problem with vegetation is the time that it takes for the vegetation to propagate and/or root into the soil. Seed germination suffers from the deficiencies of slow root growth and inadequate water retention. To facilitate vegetation growth, prefabricated seed carriers were developed, such as disclosed in for example, U.S. Pat. No. 2,648,165 to Nestor; U.S. Pat. No. 2,826,865 to Chohamin; U.S. Pat. No. 2,909,003 to Marshall; and U.S. Pat. No. 3,914,901 to Muldner.

Seed carriers are well known in the art and often suffer from problems in that they are difficult to handle, contain non-biodegradable components, contain non-homogenous mixtures, suffer poor water retention characteristics, and have a poor shelf life. Most of the seed carriers developed have utilized synthetic nettings, woven and other sheet materials as support media. Nettings often are too weak to provide sufficient soil stabilization, have a tendency to tear during application, and are otherwise generally difficult to handle. The synthetic materials are expensive, and, being non-degradable, when the seeds germinate and the young seedlings/plants break through the soil and grow upwards, the non-degraded matting tends to suppress the vegetation growing beneath. The netting can also become dislodged by increased traffic and high winds. Eventually the netting must be removed by hand and since this often tears apart the soil erosion of the topsoil may result.

U.S. Pat. No. 6,557,298 to Obert et. al. discloses and claims a method for treating a seed, comprising forming on the seed a coating comprising a dry mixture of a hydrogel and an active ingredient so that the plant growth is stimulated. The hydrogel has a saturation water content and the dry mixture has a water content less than about 4% by weight of the saturation water content. The active ingredient is selected from the group consisting of pesticides, selective herbicides, chemical hybridizing agents, auxins, antibiotics and other drugs, biological attractants, growth regulators, pheromones, dyes and combinations thereof. The hydrogel and the method for its' application resists loss of coating due to abrasion encountered during handling, storage, transportation, distribution and sowing, and also provides long lasting treatment of the seed with that effect and even, if so desired, provides such treatment to the plant that later emerges from the seed.

U.S. Pat. No. 4,779,376 to Redenbaugh discloses and claims botanic seed encapsulated in a water saturated hydrogel capsule together with at least one adjuvant capable of affecting the botanic seed, the resulting plant body or the environment. The hydrogel capsule is formed from a gel agent selected from the group consisting of alginate, carrageenan, locust bean gum and a number of other suitable gel agents known in the art. The adjuvant in the hydrogel capsule is selected from the group consisting of pesticides, herbicides, insecticides, fungicides, fumigants, repellants, rodenticides, fertilizers, nutrients, sugars, carbohydrates, adenosine triphosphate, microorganisms, growth regulating agents and the like.

U.S. Pat. No. 5,572,827 to Conrad et. al. discloses a method of applying a cross-linked hydrogel coating to embryonic plants to improve early plant growth by controlling the amount of cross-linking, comprising building up a dry coating consisting of a water-soluble hydrogel in powder form, said powder being capable of cross-linking reaction with polyvalent metal ions when hydrated to gel form. The individual powder-coated embryonic plants are then placed or immersed into a water bath free of polyvalent metal ions to partially hydrate the coatings. Before the coatings are fully hydrated, said bath is modified by dispersing cross-linking polyvalent metal ions therein. The polyvalent metal ions diffuse into the coatings and form an inwardly decreasing concentration gradient therein, the outer portions of the coatings being more highly cross-linked than the inner portions. The polyvalent metal ions in the coatings are in a uniformly partially cross-linked condition which allegedly promotes leaf emergence and plant vigor.

U.S. Pat. No. 5,771,632 to Liu et. al. discloses an artificial seed that has a hydrophobic powder padded layer or coating surrounding the seed that has a sealing material to prevent contamination thereof. This powder layer, 2-30 mm preferably 5-20 mm in thickness, consists of numerous fine sandy hydrophobic particles. The openings among the particles are small and block micro-organisms from penetrating this dry and nutrient-less layer into the seed, but not enough to block needed oxygen. The hydrophobic nature of the particles is also effective to block water permeation and microbes therein, but not effective to block the tissue to grow out of the seed. After sowing and watering the artificial seed in non-sterile soil, the water-soluble film is dissolved but the powder layer is still kept in position by the surrounding soil. The germination process is very much like that of a real botanical seed.

U.S. Pat. No. 7,921,598 to Nishiyama et. al. teaches a gel-coated seed comprising: a seed of a plant; and a coating layer disposed on the seed, said coating layer comprised of an alginic acid-based gel-forming solution containing grains of carboxymethylcellulose-based water-containing hydrophilic polymer dispersed therein. The alginic acid-based gel-forming solution is formulated in the presence of a gelling agent consisting of a multivalent ion such as calcium, sodium or potassium chloride and /or mixtures thereof. The carboxymethyl-cellulose-based, water-containing hydrophilic polymer is coated onto the seed at a concentration of between 0.2% by weight and 0.8% by weight. The resulting gel-coated seed has sufficient strength for handling and enhanced seedling survival both immediately after production thereof and after recovery following storage under drying. In an article by A. Rehman et al. Plant Soil Environ., 57, 2011 (7): 321-325 it is asserted that that hydrogel addition to the soil was effective in improving soil moisture availability and thus increased plant establishment. It is also well documented that the addition of gel-polymers has the potential to improve plant vegetative growth by retaining a higher moisture content therein.

The present invention is similar to those described above and is focused on compositions and methods for improved seed germination, propagation, and plant growth for increased crop production and yields comprising hydrogel coated seeds wherein the coating is comprised of a hydrogel composition consisting of a gelatin comprised of naturally derived proteins and one or more polysaccharides. The composition is therefore bio-degradable and stimulates plant growth and plant development without any chemical residuals left in the soil.

Hydrogels are comprised of networks polymer chains that are hydrophilic, in which water is the dispersion medium. They are highly absorbent and can contain over 99.9% water within natural or synthetic polymers. Hydrogel materials also possess a degree of flexibility very similar to natural tissue, due to their significant water content. Common uses known in the art include scaffolds in tissue engineering in which the hydrogels contain human cells to repair tissue or are used for cell culture. Environmentally sensitive hydrogels are also known as ‘Smart Gels’ or ‘Intelligent Gels’ and these have the ability to sense changes of pH, temperature, or the concentration of metabolite and release the active drug or other incorporated materian as result of such a change. As such they are useful as sustained-release drug delivery systems and other uses where water absorbtion and retention is important.

### SUMMARY OF THE INVENTION

The present invention comprises hydrogel formulations and their use in agricultural and horticultural applications, seed production and plant physiology/biochemistry. More specifically, the present invention is a bio-degradable hydrogel composition comprising gelatin and either a unsulfated- or a sulfated polysaccharide which has super-absorbent characteristics that make it a useful seed coating material to stimulate seed propagation, growth and development in agriculture, particularly in arid areas not conducive to agronomic success. The gelatin is preferably a denatured protein material such as that derived from porcine, porcine skin type—A, or bovine bone, hide, and bovine skin. The gelatin may or may not be cross-linked and the polysaccharide is selected from the group consisting of sodium cellulose sulfate, dextran sulfate, sulfated chitosan and sulfated starch. Preferably, the biodegradable hydrogel composition also contains a rheological modifier such as a clay. The hydrogel coating reduces the need for repeated watering to saturate the seed during early stages of germination initiation. The hydrogel water retention and slow release profiles provide a reservoir of water that the seed can draw upon on demand.”

### BRIEF DESCRIPTION OF THE DRAWINGS

FIG. 1 is a graphic plot showing the relative amount of water absorbency as a function of the amount of dextran sulfate in the gelatin/polysaccharide composition

FIG. 2 is a graphic plot showing the relative amount of water absorbency as a function of the amount of cellulose sulfate in the gelatin/polysaccharide composition

FIG. 3 is a graphic plot showing the relative amount of water absorbency as a function of the amount of dextran sulfate in the gelatin/polysaccharide composition

FIG. 4 is a graphic plot showing the relative amount of water absorbency as a function of the amount of cellulose sulfate in the hydrogel in the gelatin/polysaccharide composition

FIG. 5 is a series of photographs showing the comparative swelling differentials of two species of bean types coated with the hydrogel composition

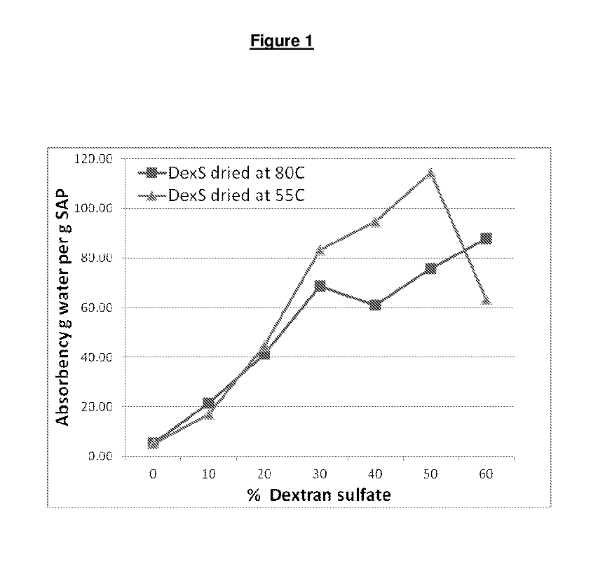

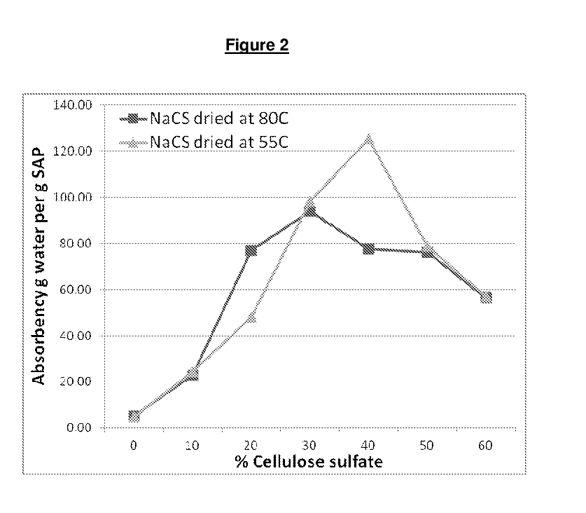

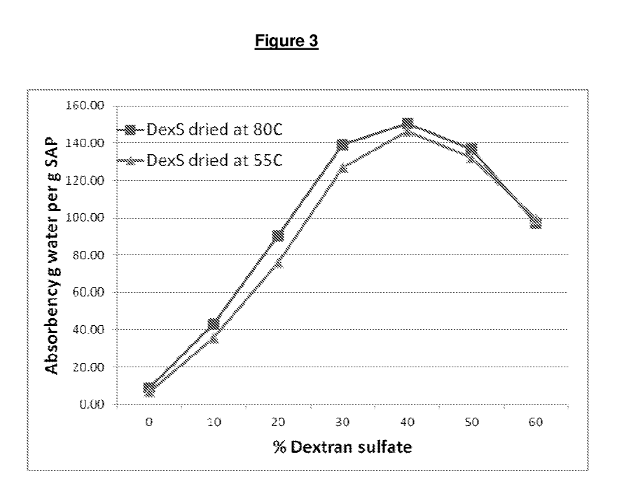

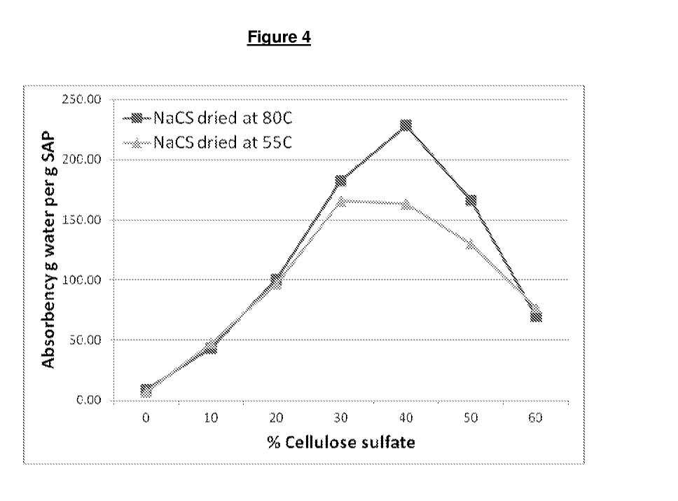

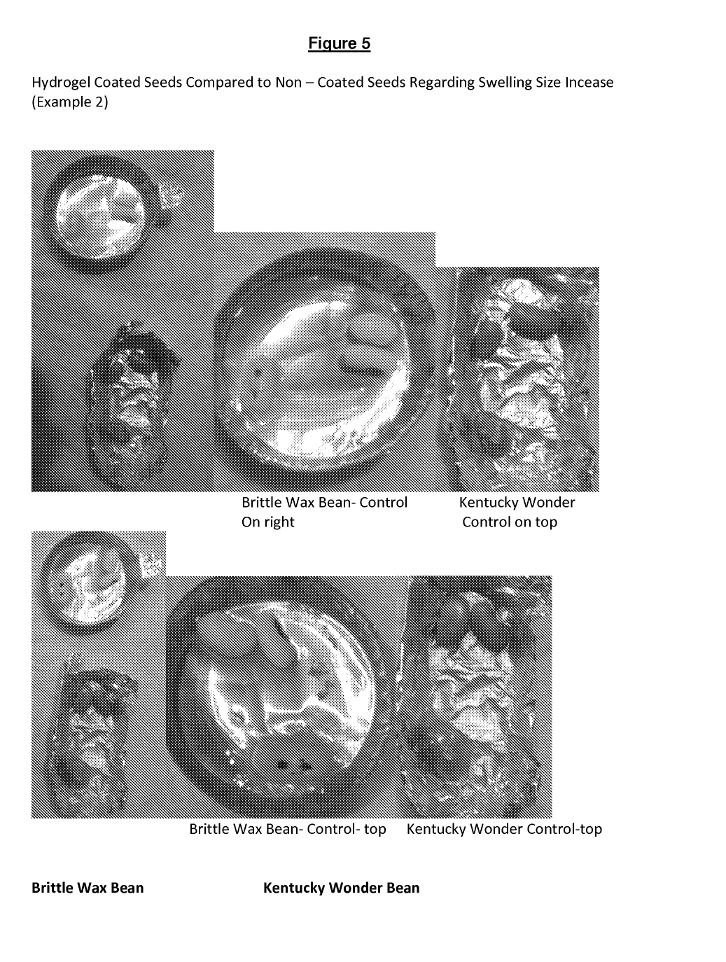

### DETAILED DESCRIPTION OF THE INVENTION

The present invention then comprises formulations consisting of gelatin and sulfated polysaccharides that are combined into gel blends capable of forming a coating on seeds to stimulate for superior germination. These hydrogels are biodegradable and capable of absorbing large amounts of water which ultimately reduces the amount of water needed for germination to begin.

Many hydrogels as discussed above have been used in a similar capacity in the past. However, these hydrogels are formed from alginates, carrageenan gums, and either a polyacrylamide or polyacrylic acid polymer backbone. The base technology is often used commercially in materials known as super absorbents and is comprised of synthetic polymers that have significant water retention capabilities but extremely poor biodegradability. Hence, while they serve to provide a water-on-demand resource for new seeds in the planting processes utilized in agriculture, forestry and land conservation, their continued residence in the soil is a problem that results in soil contamination and water run-off pollution.

It was surprisingly and unexpectedly discovered that hydrogels comprised of either a sulfated or non-sulfated (neutral) polysaccharide and a proteinaceous material such as that derived from a bovine, porcine, soy or other high protein source, will provide an effective hydrogel that has the dual advantage of being both biodegradable and obtainable from renewable resources. These hydrogels of the present invention may optionally also include a clay (a bentonite or kaolin, for example) therein so as to provide the hydrogel the added benefit of hydrogel durability and rigidity during dry storage for easier transport and better shelf life. Furthermore, the clays also provide an additional immediate hydration upon first wetting. The hydrogel formulation of the present invention is prepared as follows. A sulfated polysaccharide is mixed in aqueous solutions of a gelatin and then allowed to gel. In some embodiments of the invention, a cross-linking agent is added after the gelatin and polysaccharide are mixed together. The formed hydrogel is then used to coat the seeds of interest. Typically the seed mixture is slurried and then dried at a temperature that is not adverse to the particular seeds physiology until the hydrogel hardens, i.e., generally under 135° F. In another embodiment of the invention a desiccant may be added at room temperature or alternatively a combination of heat and vacuum may be used.

The gelatin/polysaccharide formulations the present invention will be comprised of from about 20× to about 150× its weight with water when contacted upon wetting. The hydrogel formulations may also be prepared with a cross-linking agent selected from the group comprising epoxy forms of sugars, amido-sugars, amido-polyethylene glycols and like compounds capable of forming an aldol-, a Mannich-, or a Maillard-like reaction with the gelatin. Any source of gelatin and other proteinaceous materials able to form gels are contemplated within the present embodiment including but not limited to porcine, porcine skin type A, bone, bovine hide and skin, soy protein isolates and engineered polypeptides.

The sulfated polysaccharide compounds include, but are not limited to sodium cellulose sulfate, dextran sulfate, sulfated chitosan and sulfated starch. Neutral (unsulfated) polysaccharides may be selected from the group comprising cellulose, dextran, starch and chitosan. The sulfated starches may be those derived from corn, potato, rice and/or soy and these are of particular interest because these are renewable, widely available plant-based materials. Preferred neutral polysaccharide compounds contemplated within the scope of the present invention include but are not limited to dextran or starch, with particular interest in neutral starches such as corn and plant-derived starches.

Whereas these polysaccharides are preferred, it is important to make a distinction between two classes of polysaccharides. Structural polysaccharides are those such as, but not limited to, cellulose and chitin. These are insoluble in water due in large part to β-linkages (1-4 β-linkages in the case of cellulose and chitin). These linkages cause the polysaccharides to be more difficult to hydrolyze and obtain glucose recovery. The effect of this β-linkage requires structural polysaccharides to be at least partially sulfated on order to be useful due to their lack of solubility otherwise.

Another embodiment of the present invention is the inclusion of clays in the hydrogel formulation which were found to modify the behavior of the hydrogels in an unanticipated and unexpected manner. The inclusion of clays in the formulation cause gelatin-based hydrogels to change their rheological characteristics, a performance effect due to a change in the compositions' overall ionic charge. Moreover, it was surprisingly found that this behavior is controllable by adjusting and balancing the clay type in a weight percent variation based on the total weight in order to either strengthen or reduce the rigidity of the hydrogel on demand without altering the water uptake characteristics. Suitable clays useful in the practice of the present invention include kaolin, bentonite, montmorillonite-smectite, illite, chlorite and mixtures thereof. In this manner, the clays not only modify the durability of the hydrogel composition, but also improve the hydration characteristics thereof and less water is needed from the surrounding environment to trigger seed germination. The hydrogel durability is enhanced during dry storage, and hydrogel rigidity is maintained in the same state for durability and rigidity during dry storage for easier transport and better shelf life. Furthermore, these clays provide additional and immediate hydration upon first wetting.

Preferably, polysaccharides based on dextran, cellulose, or other saturated cyclic organic hydrocarbon that has an oxygen content of at least n=1 relative to the hydrogen content is useful in preparing the hydrogel. The second part is the gelatin derived from a denatured animal protein chain of either animal or vegetable in origin. The hydrogel, once formed, may be coated onto a seed. The coating may be applied as a slurry or spray dried onto the seed. The hydrogel can also be slowly evaporated onto the seed coat but the preferred embodiment is by the application of low heat between 20° C. and 70° C., this being an effective means to form a dry shell about the seed in as little as one hour. Preferably, the seeds are dried at a temperature range of from about 35° C. to about 75° C. Surprisingly this fast drying is unexpected as the excess water is removed more quickly than anticipated and in fact makes this discovery a benefit for not over-wetting the seeds. Alternatively flash drying can be used although care will be needed to protect the seeds from sudden heat over-exposure and desiccation.

Germination rates were shown to be accelerated in comparison tests in-vitro and in-vivo. In both environments seeds coated with the hydrogel germinated faster and resulted in seedlings that were more robust and became larger plants. The present invention also comprises a method to enhance seed protection and propagation, that consists of coating the seed with the hydrogel comprised of a gelatin/polysaccharide matrix/formulation which is then dried thereon. The seeds are first coated with the bio-degradable hydrogel that is then dried and hardened onto the seed coat by thermal exposure at a temperature of from about 20 to about 70 degrees centigrade. Optionally, the water content of the hydrogel formulation after preparation may be subsequently reduced by from about 1.0% to about 20.0% by the replacement of a portion of the water therein with an alcohol prior to coating the seeds in order to speed the drying process. In some situations, cellulose derivatives by themselves without gelatin may also beneneficial.

The seed composition may further comprise an additive to further promote growth and otherwise protect the embryonic seedling from invasive micro-organisms which feed on the proteins and polysaccharides of the coating and the young plant. These may comprise fertilizers, insecticides, fungicides and bacteriocides. Suitable fertilizers include mono- and dibasic ammonium phosphates and their calcium and magnesium salts, ammonium nitrates and mixtures thereof. Useful insecticides comprise azoxystrobin, cycloheximide, streptomycin, malaxyl, thiabendazole, copper sulfate, chlorothalonil, carbon disulfide, copper octanoate, mancozeb, tebuconazole, and mixtures thereof.

The following examples are provided to more specifically set forth and define the process of the present invention. It is recognized that changes may be made to the specific parameters and ranges disclosed herein and that there may be a number of different ways known in the art to change the disclosed variables. And whereas it is understood that only the preferred embodiments of these elements are disclosed herein as set forth in the specification and drawings, the invention should not be so limited and should be construed in terms of the spirit and scope of the claims that follow.

### EXAMPLE 1

A number (7) of hydrogel compositions comprising bovine protein-derived gelatin and two sulfated polysaccharide compounds were prepared in two batches, A and B. The first hydrogel composition (1) was prepared by combining dextran sulfate with gelatin in a weight percent ratio range of from 30:70 to 70:30 wt/wt %, in water at ambient temperature. The hydrogel was then dried for 12 hours at either 55° C. or 85° C. In batch A shown in the tables below, the gelatin/dextran sulfate compositions were formulated in gelatin/dextran sulfate ratios of from 100-40/0-60 weight percent respectively, i.e., the first sample in batch A is a formulation comprising 0% dextran sulfate and 100% gelatin; the second sample 10% dextran and 90% gelatin, etc. Their weight ratios and volumes were the determined and the samples were then weighed after one (1) hour of swelling. In batch B, gelatin/sodium cellulose sulfate compositions were formulated in similar ratios in the same manner dried and measured after swelling for one and twenty-four hours. The numbers measured for the hydrogels, which were dried at the two drying temperatures, i.e., 55° C. and 80° C. are indicative of the relative magnitude of water uptake effected by the temperature of drying.

Batch A—Relative Swelling after One Hour of Hydration

| Percent of | Dextran Sulfate | Dextran Sulfate |
|---|---|---|
| Dextran Sulfate | dried at 80° C. | dried at 55° C. |
| 0 | 5.28 | 4.92 |
| 10 | 21.65 | 16.91 |
| 20 | 41.31 | 44.55 |
| 30 | 68.58 | 83.33 |
| 40 | 60.98 | 94.81 |
| 50 | 75.82 | 114.28 |
| 60 | 87.81 | 63.39 |
| Sodium | | |
| Cellulose | | |
| Sulfate | NaCS dried at | NaCS dried at |
| (NaCS) % | 80° C. | 55° C. |
| 0 | 5.28 | 4.92 |
| 10 | 23.00 | 24.47 |
| 20 | 77.13 | 48.09 |
| 30 | 93.87 | 98.18 |
| 40 | 77.46 | 125.37 |
| 50 | 76.03 | 78.84 |
| 60 | 56.39 | 56.92 |

Batch B—Relative Swelling after 24 Hours of Hydration

| | DexS dried at | DexS dried at |
|---|---|---|
| % of DexS | 80° C. | 55° C. |
| 0 | 8.79 | 6.83 |
| 10 | 43.24 | 35.79 |
| 20 | 90.44 | 75.89 |
| 30 | 139.27 | 126.74 |
| 40 | 150.37 | 146.39 |
| 50 | 136.74 | 132.34 |
| 60 | 97.03 | 99.28 |
| | NaCS dried at | NaCS dried at |
| % of NaCS | 80 C. | 55 C. |
| 0 | 8.79 | 6.83 |
| 10 | 43.32 | 47.39 |
| 20 | 100.60 | 96.35 |
| 30 | 182.38 | 165.73 |
| 40 | 228.28 | 163.47 |
| 50 | 166.39 | 129.94 |
| 60 | 70.00 | 76.85 |

The data above and that depicted in two graphs 3 and 4 illustrate that there is a unique correlation between drying temperature and the degree of re-wetting of the polymer. It is also evident that there is an optimum wt/wt correlation showing that when the gelatin concentration reaches 55 wt %, the solid hydrogel performs best as a super absorber. The formed hydrogel is a flow-able polymeric system and coats a large variety of seed types and varieties easily. The flowable, viscous hydrogel formulations may be applied to the seeds using any one of a number of methods known in the art such as fluid bed coating apparatus, sphereonization, spray guns, etc. The wet -coated seeds, including vegetable as well as flowering and fruit varieties, are then dried at about 20°-65° C. overnight to form a solid coating. These re-wet easily by adding water and the water is retained in the hydrogel for long periods of time.

The effect of hydrogels on embryonic plant growth and development was conducted in a sandy loam soil (75% sand, 12% silt and 13% clay). Common soil characteristics shared by the various soil were organic carbon content (0.5%); total nitrogen (0.043%); potash (1.00 ppm); potassium 187 ppm; zinc 1.54 ppm and iron 4.47 ppm. which were measured as the salts after chelation with diethylentriamene pentaacetate (DTPA) The experiment was conducted in a randomized complete block design with factorial arrangement having three replications and net plot size of 3.0 m×7.0 m. The hydrogel was randomized in main plots and sowing methods in subplots.

### EXAMPLE 2

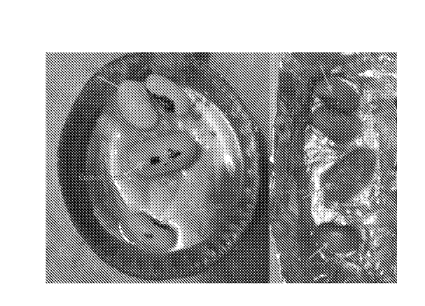

Two sets of seeds were tested for swelling enhancement caused by the hydrogel coating of the present invention (Kentucky Wonder & Brittle Wax beans from Burpee). A first set of fresh, untreated seeds is placed at the bottom of the trays. A second set of seeds were coated with hydrogel AB-50 and AB-48 by dipping and slurry and then drying @˜130° F. for about 4 hrs. The seeds were then placed in water (2.5 ml; ½ tsp) overnight along with untreated seeds that were also heated at ˜130° F. for 4 hours drying time. Referring now to FIG. 5, pictures of the seeds show the initial states of the beans coated with the hydrogel as compared to those that were not coated. After twelve hours of soaking, there is a decided increase in hydration by the coated as opposed to the non-coated seeds. Examination of the seeds for the effect of coating accentuated the appearance of ‘swelling’. The coated seeds were gently stripped of the hydrogel with a plastic spoon.

### EXAMPLE 3

The procedure set forth in example 2 was carried out again in order to show that the amount of water absorbed by the coating is controllable by the amount of isosorbide cross-linking agent is incorporated into the coating composition. This led to the the un-anticipated discovery that combining a specific amount of either cellulose sulfate or dextran sulfate with bovine gelatin works without any cross-linking modifier. Sixteen (16) cellulose sulfate (40%) or dextran sulfate (40%) with bovine gelatin formulations were prepared with varying amounts iso-sorbide cross-linker from 0.2-0%. The amount of water uptake by the coatings was measured after the seeds were placed in water (H₂O) and a 0.9% saline solution for twelve (12) hours. The amount of water uptake was measured as a function of total seed weight (wt %). The results are set forth below.

| | 40% Sodium Cellulose | | 40% Sodium Dextran | |
|---|---|---|---|---|
| | Sulfate | | Sulfate | |
| | DI Water | 0.9% Saline | DI Water | 0.9% Saline |
| % | Average | Average | Average | Average |
| Crosslinker | WT % H₂O Uptake | | WT % H₂O Uptake | |
| 0 | 141 26 | 10.94 | 114.3 | 11.38 |
| 0.005 | 125.87 | 15.64 | 119.41 | 10.55 |
| 0.02 | 134.24 | 13.81 | 115.17 | 11.92 |
| 0.05 | 154.47 | 14.02 | 120.4 | 12.85 |
| 0.1 | 158.20 | 14.45 | 117.38 | 11 |
| 0.2 | 157.33 | 14.04 | 93.57 | 11.58 |
| 0.5 | 124.46 | 11.31 | 59.45 | 10.28 |
| 1 | 75.04 | 9.09 | 30.06 | 8.22 |

DI = deionized water

It can be seen from the results above that as the amount of cross-linker in each formulation was increased from 0.0-1.0% the amount of water absorbed generally increased in formulations comprising up to 0.2% isosorbide with a sodium cellulose sulfate/isosorbate composition exhibiting the highest degree of absorbancy. Seeds coated accordingly also exhibited the highest rate of germination

What is claimed is:

1. A bio-degradeable seed coating composition for enhanced seed protection and propagation comprising a gelatin-based hydrogel formulation consisting of a naturally derived, hydrophilic protein in combination with a sulfated or neutral non-sulfated polysaccharide.

2. The bio-degradable seed coating composition of claim 1 wherein said protein is derived from a porcine, porcine skin type A, bone, bovine hide, soy heavy protein extract and genetically engineered cells.

3. The bio-degradable seed coating composition of claim 2 wherein said sulfated polysaccharide is selected from the group consisting of sodium cellulose sulfate, dextran sulfate, sulfated chitosan, sulfated starch and mixtures thereof.

4. The seed coating composition of claim 3 wherein said sulfated starch is derived from corn, potato, rice and/or soy.

5. The seed coating composition of claim 4 further comprising a rheology modifier.

6. The seed coating composition of claim 5 wherein said rheology modifier is a clay, a dessicant or silica gel.

7. The seed coating composition of claim 6 wherein said clay is selected from the group consisting of kaolin, bentonite, montmorillonite-smectite, illite, chlorite and mixtures thereof.

8. The seed coating composition of claim 7 wherein said the protein/sulfated polysaccharide weight ratios in the seed coating composition are from about 100-40 wt/wt %. to about 0-60 weight percent.

9. The seed coating composition of claim 8 wherein said the protein/sulfated polysaccharide weight percent ratios in the seed coating composition are from about 30:70 to about 70:30 wt/wt %.

10. The seed coating composition of claim 9 wherein said sulfated polysaccharide compound is cross-linked.

11. The seed coating composition of claim 10 wherein said cross-linking agent is selected from the group comprising epoxy sugars, amido-sugars, amido-polyethylene glycols and compounds capable of forming an aldol-, a Mannich-, or a Michael reaction with the hydrosylate.

12. The seed coating composition of claim 11 wherein the water content of the hydrogel formulation is reduced by from about 1.0% to about 20.0% by the replacement of a portion of the water therein with an alcohol prior to seed coating.

13. The seed coating composition of claim 12 wherein said alcohol is selected from the group consisting of ethanol, isopropanol, propylene glycol and mixtures thereof.

14. The seed composition of claim 13 wherein said composition further comprises a protectant additive selective from the group consisting of fertilizers, insecticides, fungicides and bacteriocides.

15. The seed composition of claim 14 wherein the fertilizer is selected from the group consisting of mono- and dibasic ammonium phosphates and their calcium and magnesium salts, ammonium nitrates and mixtures thereof.

16. The seed composition of claim 15 wherein said insecticide is selected from the group consisting of azoxystrobin, cycloheximide, streptomycin, malaxyl, thiabendazole, copper sulfate, chlorothalonil, carbon disulfide, copper octanoate, mancozeb, tebuconazole, and mixtures thereof.

17. A method to enhance seed protection and propagation comprising coating said seed with a gelatin-based hydrogel consisting of a naturally derived, hydrophilic protein in combination with a sulfated or non-sulfated neutral polysaccharide which is then dried thereon.

18. The method of claim 17 wherein said method comprises coating the seed with a gelatin-based hydrogel formulation consisting of a naturally derived, hydrophilic protein in combination with a sulfated or non-sulfated neutral polysaccharide which is the allowed to dry.

19. The method of claim 15 wherein said hydrophilic protein is derived from a porcine, porcine skin type A, bone, bovine hide, soy heavy protein extract and genetically engineered cells.

20. The method claim 19 wherein said sulfated polysaccharide is selected from the group consisting of sodium cellulose sulfate, dextran sulfate, sulfated chitosan, sulfated starch and mixtures thereof.

21. The method of claim 22 further comprising a rheology modifier comprising clay, a dessicant or silica gel.

22. The method of claim 21 wherein said clay is selected from the group consisting of kaolin, bentonite, montmorillonite-smectite, illite, chlorite and mixtures thereof.

23. The method of claim 22 wherein said the protein/sulfated polysaccharide ratios in the seed coating composition are from about 40-100 wt/wt % to about 60-0 wt/wt %.

24. The method of claim 23 wherein said the protein/sulfated polysaccharide ratios in the seed coating composition are from about 30:70 to 70:30 wt/wt %.

25. The method of claim 24 wherein the seed coating hydrogel composition is dried and hardened onto the seed coat by thermal exposure at a temperature of from about 30 to about 70 degrees centigrade.

26. The method of claim 25 wherein the seed coating hydrogel composition is dried and hardened onto the seed coat by dessication at room temperature.

27. A bio-degradable seed coating composition for enhanced seed protection And propagation comprising a sulfated or neutral non-sulfated polysaccharide.
